(19) United States
(12) Patent Application Publication
(10) Pub. No.: US 2025/0193917 A1
(43) Pub. Date: Jun. 12, 2025

(54) SYSTEMS AND METHODS FOR QUEUING PACKETS FOR WIRELESS NETWORK TRANSMISSION

(71) Applicant: Georgia Tech Research Corporation, Atlanta, GA (US)

(72) Inventors: Raghupathy Sivakumar, Johns Creek, GA (US); Ching-Lun Tai, Atlanta, GA (US); Shyam Krishnan Venkateswaran, Atlanta, GA (US)

(21) Appl. No.: 18/952,045

(22) Filed: Nov. 19, 2024

Related U.S. Application Data
(60) Provisional application No. 63/608,168, filed on Dec. 8, 2023.

(51) Int. Cl. H04W 72/542; H04W 28/02

(52) U.S. Cl. CPC H04W 72/542; H04W 28/0236

(57) ABSTRACT

A method for queuing packets for wireless network transmission including determining a selected device based on rankings of a first client device and a second client device, determining a transmission link for the selected device by probabilistically selecting the transmission link from a number of transmission links based on a transmission link score indicating a connection quality of the transmission link, queuing data from the selected device in a transmission queue for transmission via the determined transmission link, and updating the weight for each client device of the first client device and the second client device based on whether data from the client device was added to the transmission queue.

### CROSS-REFERENCE TO RELATED APPLICATIONS

This application claims the benefit of U.S. Provisional Patent Application No. 63/608,168, filed Dec. 8, 2023, the entire contents of which are incorporated herein by reference.

### BACKGROUND

The present disclosure relates generally to the field of wireless networking, and more specifically to systems and methods for queuing packets for multi-link wireless network transmission. In multi-link operation, a device (e.g., phone, tablet) may simultaneously connect to multiple frequency bands of a network (e.g., 2.4 GHz, 5 GHZ, and/or 6 GHZ). Conventional devices may be unable to distribute traffic across frequency bands which may result in limited bandwidths and high latency.

### SUMMARY

One implementation of the present disclosure is a method for queuing packets for wireless network transmission including, for each client device of a first client device and a second client device, generating a weight for the client device, wherein the weight indicates a transmission priority associated with the client device, generating a score for the client device based on (i) the weight and (ii) an amount of data to be transmitted from the client device, and ranking the client device based on the score. The method includes determining a selected device based on the rankings of the first client device and the second client device, determining a transmission link for the selected device by probabilistically selecting the transmission link from a number of transmission links based on a transmission link score indicating a connection quality of the transmission link, queuing data from the selected device in a transmission queue for transmission via the determined transmission link, and updating the weight for each client device of the first client device and the second client device based on whether data from the client device was added to the transmission queue.

In some embodiments, determining the transmission link for the selected device includes identifying, from the number of transmission links, candidate transmission links based on (i) an amount of data to be transmitted from the selected device and (ii) a remaining transmission capacity associated with each of the number of transmission links. In some embodiments, determining the transmission link for the selected device includes generating a probability distribution associated with the candidate transmission links based on a transmission link score associated with each of the candidate transmission links. In some embodiments, selecting the transmission link includes selecting the transmission link based on the probability distribution. In some embodiments, the method includes generating the transmission link score based on an indication of a connection quality associated with each of the number of transmission links. In some embodiments, the indication of a connection quality includes at least one of (i) a signal-to-noise ratio, (ii) an amount of data received, or (iii) an indication of channel occupancy. In some embodiments, updating the weight for the client device includes updating the weight to increase the transmission priority associated with the client device in response to determining that the data from the client device was not added to the transmission queue. In some embodiments, the transmission link is a wireless connection between the selected device and a wireless access point.

Another implementation of the present disclosure is a wireless access point including a processing circuit having a processor and memory, the memory having instructions stored thereon that, when executed by the processor, cause the processor to, for each client device of a number of client devices, generate a weight for the client device, wherein the weight indicates a transmission priority associated with the client device, generate a score for the client device based on (i) the weight and (ii) an amount of data to be transmitted from the client device, and rank the client device based on the score. In some embodiments, the instructions cause the processor to determine a selected device based on the rankings, determine a transmission link for the selected device by probabilistically selecting the transmission link from a number of transmission links based on a transmission link score indicating a connection quality of the transmission link, queue data from the selected device in a transmission queue for transmission via the determined transmission link, and updating the weight for each client device of the number of client devices based on whether data from the client device was added to the transmission queue.

In some embodiments, determining the transmission link for the selected device includes identifying, from the number of transmission links, candidate transmission links based on (i) an amount of data to be transmitted from the selected device and (ii) a remaining transmission capacity associated with each of the number of transmission links. In some embodiments, determining the transmission link for the selected device includes generating a probability distribution associated with the candidate transmission links based on a transmission link score associated with each of the candidate transmission links. In some embodiments, selecting the transmission link includes selecting the transmission link based on the probability distribution. In some embodiments, the instructions further cause the processor to generate the transmission link score based on an indication of a connection quality associated with each of the number of transmission links. In some embodiments, the indication of a connection quality includes at least one of (i) a signal-to-noise ratio, (ii) an amount of data received, or (iii) an indication of channel occupancy. In some embodiments, updating the weight for the client device includes updating the weight to increase the transmission priority associated with the client device in response to determining that the data from the client device was not added to the transmission queue.

Another implementation of the present disclosure is a non-transitory computer-readable storage medium having instructions stored thereon that, when executed by a processor, cause the processor to determine a selected device from a number of devices based on a ranking associated with each of the number of devices, determine a transmission link for the selected device by probabilistically selecting the transmission link from a number of transmission links based on a transmission link score indicating a connection quality of the transmission link, queue data from the selected device in a transmission queue for transmission via the determined transmission link, and update a weight for each of the number of devices based on whether data from each of the number of devices was added to the transmission queue, wherein the weight indicates a transmission priority.

In some embodiments, determining the transmission link for the selected device includes identifying, from the number of transmission links, candidate transmission links based on (i) an amount of data to be transmitted from the selected device and (ii) a remaining transmission capacity associated with each of the number of transmission links. In some embodiments, determining the transmission link for the selected device includes generating a probability distribution associated with the candidate transmission links based on a transmission link score associated with each of the candidate transmission links. In some embodiments, selecting the transmission link includes selecting the transmission link based on the probability distribution. In some embodiments, the instructions further cause the processor to generate the transmission link score based on an indication of a connection quality associated with each of the number of transmission links. In some embodiments, the indication of a connection quality includes at least one of (i) a signal-to-noise ratio, (ii) an amount of data received, or (iii) an indication of channel occupancy. In some embodiments, updating the weight for each of the number of devices includes updating the weight to increase the transmission priority associated with the device in response to determining that the data from the device was not added to the transmission queue. In some embodiments, the transmission link is a wireless connection between the selected device and a wireless access point.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 is a block diagram illustrating a number of networked devices, according to an exemplary embodiment.

FIGS. 2A-2B illustrate a method of queuing data packets for wireless network transmission, according to an exemplary embodiment.

FIG. 3 illustrates a method of determining a transmission link, according to an exemplary embodiment.

FIG. 4 illustrates another method of determining a transmission link, according to an exemplary embodiment.

FIG. 5 illustrates a method of generating a transmission link score, according to an exemplary embodiment.

FIG. 6 is a block diagram of an access point, according to an exemplary embodiment.

FIGS. 7-9 are graphs illustrating experimental results from a study that was conducted, according to an exemplary embodiment.

### DETAILED DESCRIPTION

Referring generally to the FIGURES, described herein are systems and methods for queuing packets for wireless network transmission. In various embodiments, the systems and methods of the present disclosure facilitate queuing packets for wireless network transmission in a manner that balances (i) network throughput and (ii) fairness. Specifically, systems and methods of the present disclosure may determine how to transmit data from a number of client devices using limited bandwidth in a manner that promotes efficient use of the limited bandwidth while ensuring that each of the number of client devices are treated fairly relative to one another.

As an extended example, a first client device may have first data (e.g., packets, frame, etc.) to transmit and a second client device may have second data to transmit. An access point (e.g., wireless access point, router, etc.) may identify a number of transmission links between (i) the access point and (ii) the first client device and/or the second client device. For example, there may be five transmission links between first client device and the access point and there may be ten transmission links between second client device and the access point. For each of the number of transmission links, the access point may generate a transmission link score indicating a connection quality of the transmission link. Further, the access point may score and/or rank the first client device and the second client device based on a “utility per byte” associated with each client device. For example, the first client device may be assigned a score of 2.5 and the second client device may be assigned a score of 8.3. To continue the example, the access point may select the second client device based on its score and/or its ranking. The access point may determine a number of candidate transmission links associated with the second client device (e.g., the selected client device) and deterministically select a candidate transmission link from the number of candidate transmission links to send the second data. The access point may queue the second data in a transmission queue associated with the deterministically selected candidate transmission link for transmission. In response to queueing the second data and not queueing the first data, the access point may update the score associated with the first client device and the second client device to make the first client device more likely than the second client device to be selected for data transmission in the future.

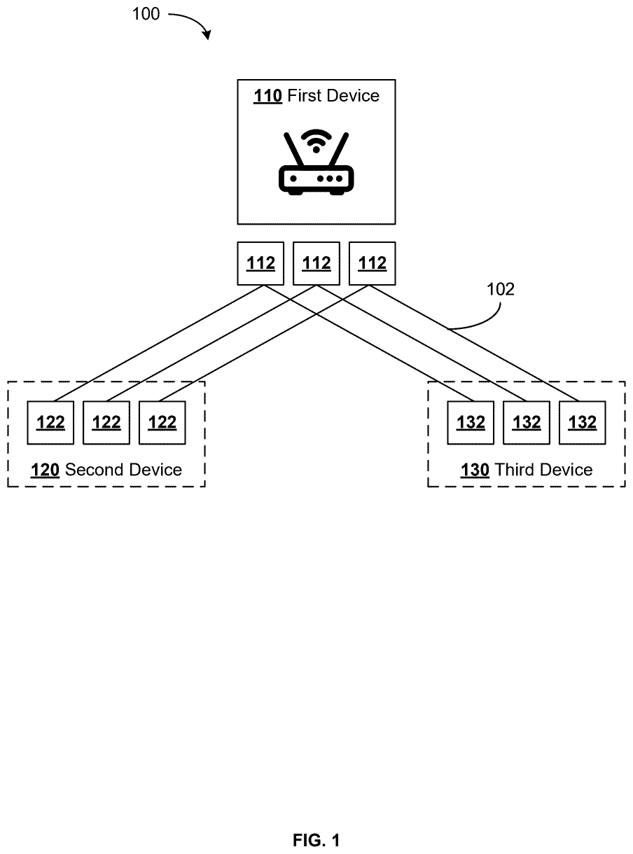

Hereinafter, example embodiments are described in greater detail with reference to the accompanying drawings. Referring now to FIG. 1, a block diagram illustrating networked environment 100 is shown, according to an exemplary embodiment. Networked environment 100 is shown to include first device 110, second device 120, and third device 130. In various embodiments, first device 110 is an access point (e.g., router, etc.). In various embodiments, second device 120 and/or third device 130 are client devices. For example, second device 120 may be a smartphone and third device 130 may be a laptop computer. In various embodiments, networked environment 100 is a wireless networked environment. For example, first device 110, second device 120, and/or third device 130 may communicate wirelessly using a wireless network protocol such as those based on IEEE 802.11 promulgated by the Institute of Electrical and Electronics Engineers (IEEE). Additionally or alternatively, networked environment 100 may be and/or include a wired network environment.

First device 110 may include one or more interfaces 112. Likewise, second device 120 and third device 130 may include one or more interfaces (shown as interfaces 122 and interfaces 132, respectively). Interfaces 112-132 may be and/or include hardware and/or software to facilitate communication with other devices. For example, interfaces 112-132 may include a wireless antenna and a network interface controller. In some embodiments, each of interfaces 112-132 operate using a different frequency band. For example, a first interface of interfaces 122 may operate at 5.925 GHz to 7.125 GHz and a second interface of interfaces 122 may operate at 5.15 GHz to 5.925 GHz. In various embodiments, each of interfaces 112-132 is or is associated with an antenna (e.g., radio, radio antenna, etc.). For example, second device 120 may have a single antenna and third device 130 may have four antennas.

In various embodiments, one or more transmission links 102 (e.g., connections, etc.) exist between first device 110, second device 120, and/or third device 130. Transmission links 102 may facilitate data transmission between first device 110, second device 120, and/or third device 130. For example, first device 110 may send a first data packet to second device 120 via a first transmission link of transmission links 102 and second device 120 may send a second data packet to first device 110 via the first transmission link. In some embodiments, transmission links 102 are used separately/individually. For example, first device 110 and second device 120 may communicate using a single transmission link of transmission links 102. Additionally or alternatively, transmission links 102 may be used collectively. For example, first device 110 may transmit a data packet to second device 120 using two transmission links 102 in parallel. As another example, third device 130 may transmit a first portion of a data packet to first device 110 using a first one of transmission links 102 and may transmit a second portion of a data packet to first device 110 using a second one of transmission links 102. In various embodiments, transmission links 102 are radio frequency transmission links. In some embodiments, first device 110 is a multi-link access point. In some embodiments, second device 120 and/or third device 130 are multi-link stations. A multi-link device may be a device capable of communicating simultaneously using multiple links.

Referring now generally to networked environment 100, systems and methods of the present disclosure may offer many benefits over existing systems. Conventional systems for queuing packets for wireless transmission may facilitate load balancing. However, such conventional systems may perform load balancing based on only a single measure of transmission link quality. Conversely, systems and methods of the present disclosure may facilitate quantifying transmission link quality using a number of measures of transmission link quality, thereby improving transmission reliability and network throughput. Further, conventional systems for queuing packets for wireless transmission may not account for fairness. Specifically, such conventional systems may implicitly disadvantage devices with large data packets for transmission because it is difficult to fit the large data packets into a transmission queue having limited space. As a result, transmission of large data packets using conventional systems may be delayed relative to transmission of smaller data packets. Conversely, systems and methods of the present disclosure may facilitate “fair” queuing of packets for wireless transmission by assigning client devices a weight and updating the weight based on whether the client device was able to send data in a previous transmission such that client devices that were unable to send data in a previous transmission are favored relative to client devices that were able to send data in a previous transmission in subsequent transmissions. Additionally or alternatively, in various embodiments, systems and methods of the present disclosure facilitate balancing throughput and fairness by maximizing a weighted utility for each data transmission. For example, systems and methods of the present disclosure may facilitate maximizing the function:

$${\sum }_{l = 1}^{L} {\sum }_{m ∈ Φ l} {w}_{m} * log ( {b}_{m}^{x} )$$

where wₘ*log(bₘ^{x}) is the weighted “utility” contributed by the m^{th} device, l is an index of the transmission links (e.g., transmission links associated with an access point, etc.), and Φ is a vector indicating pairs of transmission links and devices (e.g., which transmission link each device will use to transmit data, etc.). In various embodiments, maximizing the previously referenced function is a NP-hard problem. However, by utilizing a polynomial-complexity heuristic method, systems and methods of the present disclosure may offer a simplified solution that may reduce a number of computational steps involved in queuing data packets, thereby decreasing latency, increasing throughput, and/or enabling less expensive hardware to be utilized (e.g., as compared with conventional systems).

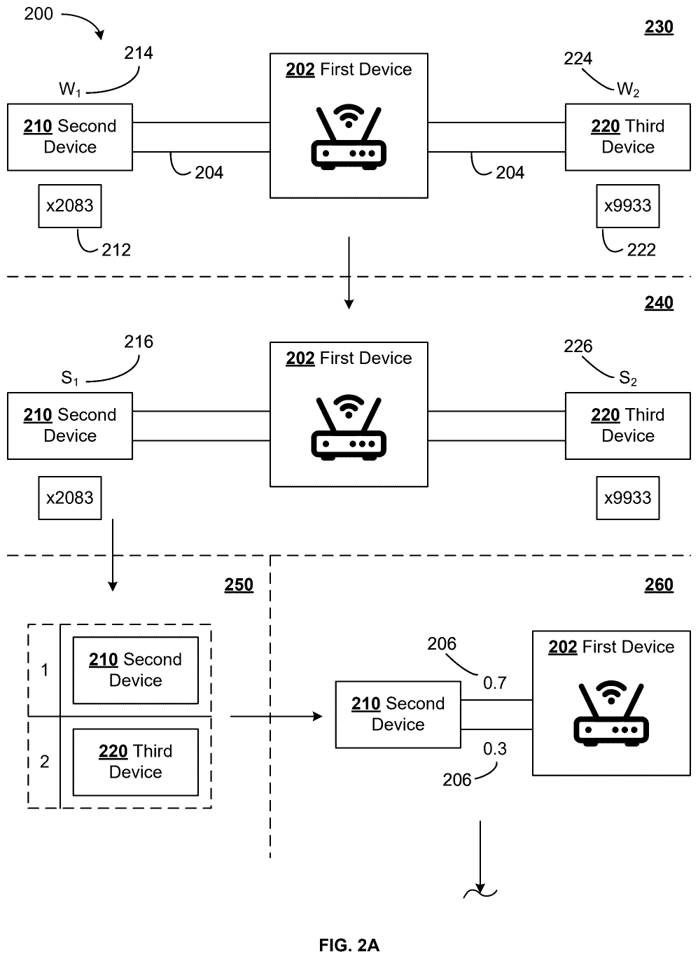

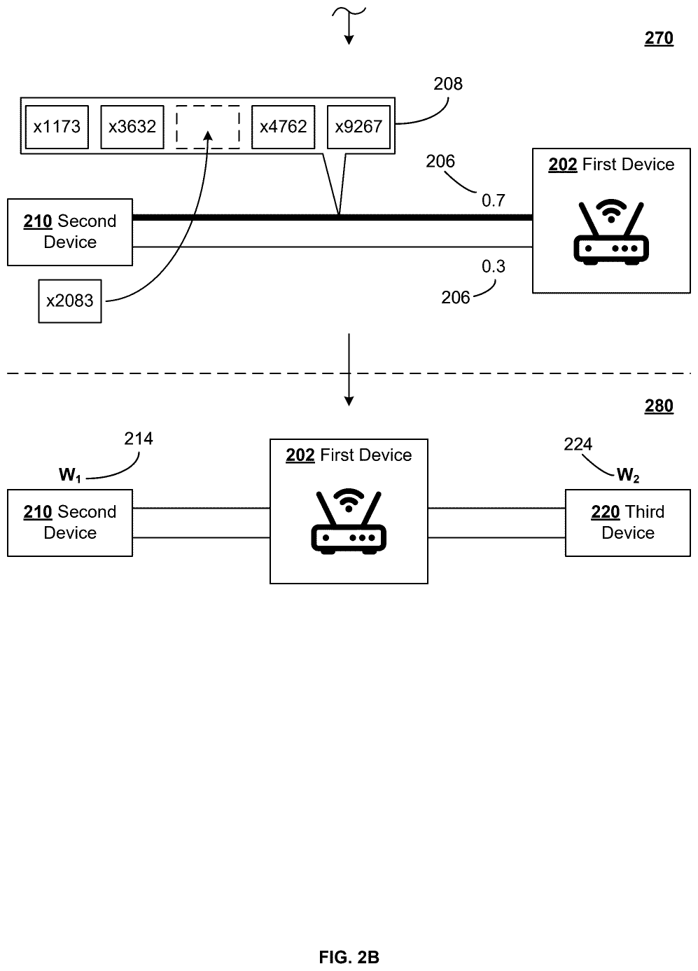

Referring now to FIGS. 2A-2B, method 200 for queuing data packets for wireless network transmission is shown, according to an exemplary embodiment. Method 200 is shown to include first device 202, second device 210, and third device 220. In various embodiments, first device 202 is the same as and/or similar to first device 110. In various embodiments, second device 210 is the same as and/or similar to second device 120. In various embodiments, third device 220 is the same as and/or similar to third device 130. Second device 210 may have first data packet 212 for transmission. Third device 220 may have second data packet 222 for transmission. First device 202, second device 210, and/or third device 220 may be connected via one or more transmission links 204. Transmission links 204 may be the same as and/or similar to transmission links 102. It should be understood that while method 200 is described in relation to a networked environment including three devices, systems and methods of the present disclosure are usable in other networked environments, including those having a different/greater number of devices. For example, method 200 may be used to queue data packets for transmission between an access point and 15 client devices each having a number of transmission links.

At step 230, first device 202 may generate weight 214 for second device 210 and/or may generate weight 224 for third device 220. Weight 214 and weight 224 may be based on a priority associated with each device. For example, weight 214 may indicate that second device 210 has a higher transmission priority than third device 220 based on a comparison of weight 214 and weight 224. In various embodiments, weight 214 and weight 224 are determined based on whether second device 210 and third device 220 respectively transmitted data in a previous transmission cycle. For example, first data packet 212 may be too large to fit in a first data transmission and therefore must be sent during a second data transmission and weight 214 may be updated to prioritize second device 210 for transmission during the second data transmission.

At step 240, first device 202 may generate score 216 for second device 210 and/or may generate score 226 for third device 220. Score 216 and/or score 226 may indicate a “utility per byte” associated with first data packet 212 and second data packet 222 respectively. In various embodiments, first device 202 generates score 216 using weight 214 and a size of first data packet 212. In various embodiments, first device 202 generates score 226 using weight 224 and a size of second data packet 222. In some embodiments, first device 202 generates score 216 and/or score 226 according to the formula:

$${Score}_{i} = {W}_{i} * \frac{log ( message {size}_{i} )}{message {size}_{i}}$$

where message sizeᵢ is a size of first data packet 212 or second data packet 222 (e.g., measured in bytes, etc.) and Wᵢ is weight 214 or weight 224.

At step 250, first device 202 may rank second device 210 and/or third device 220 based on score 216 and/or score 226. For example, second device 210 may have a score of three and third device 220 may have a score of two and first device 202 may rank second device 210 above third device 220 based on the scores. In some embodiments, step 250 includes assigning an index to second device 210 and/or third device 220 based on the ranking. For example, step 250 may include sorting M devices (e.g., {uₘ}ₘ₌₁^{M}) in descending order and creating an order of indices of devices to be addressed as j₁, j₂, . . . , j_{M}∈{1, 2, . . . , M} with uⱼ_{₁}≥uⱼ_{₂}≥ . . . ≥uⱼ_{_{M}}.

In some embodiments, step 250 includes determining a selected device based on the rankings. For example, first device 202 may select a device having the highest ranking, the highest index, and/or the like.

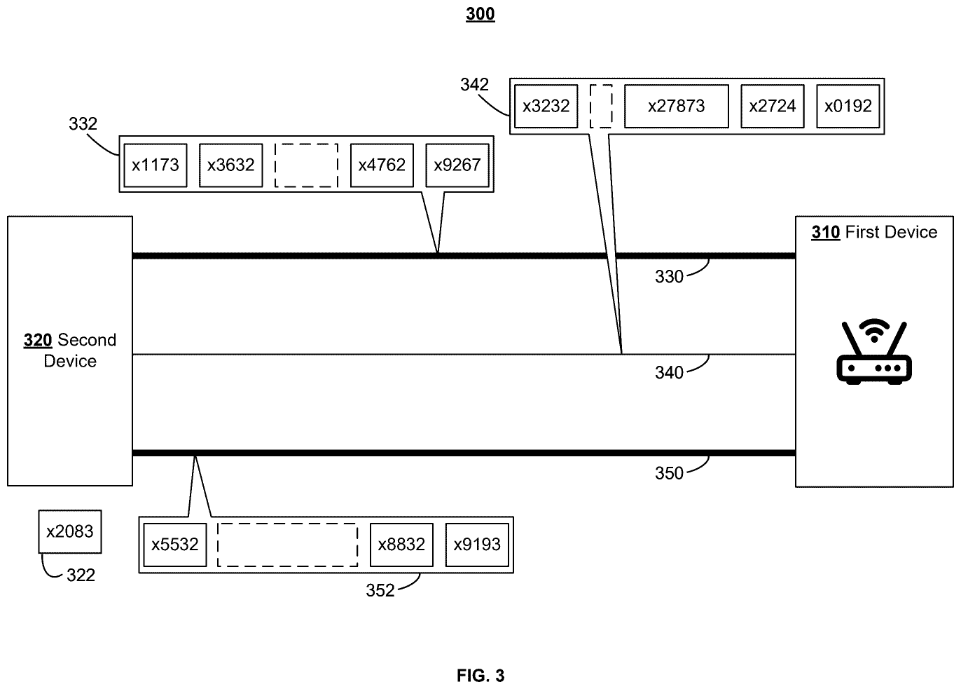

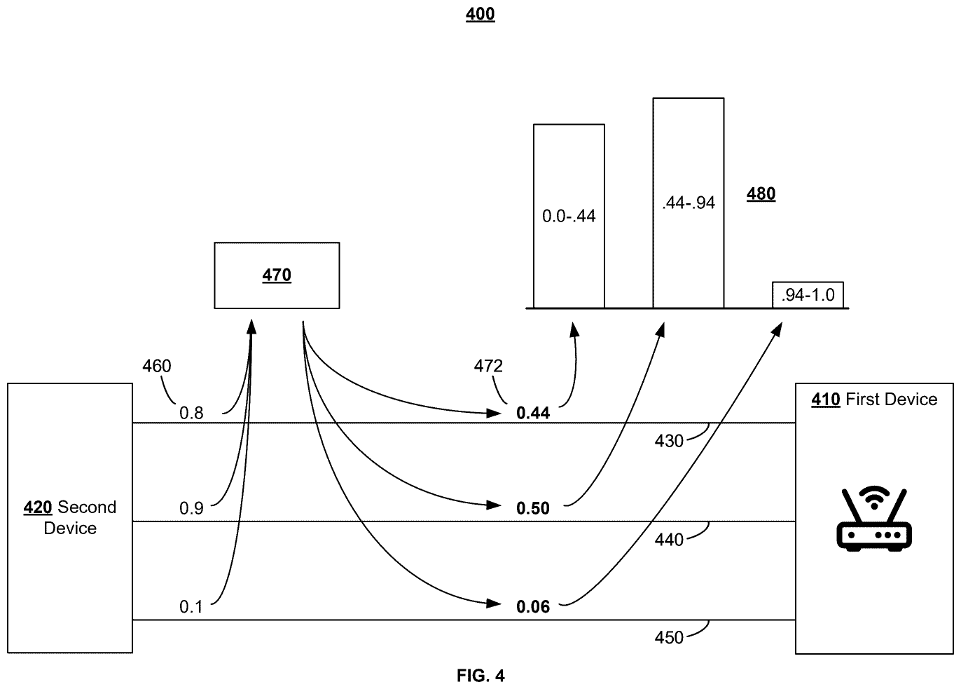

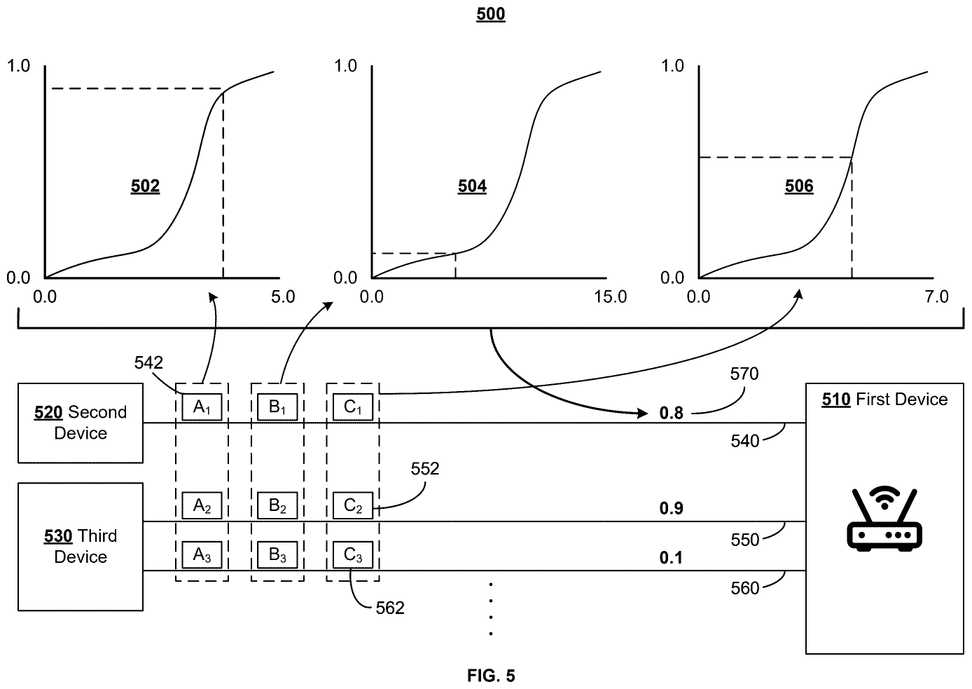

At step 260, first device 202 may determine a transmission link for the selected device by probabilistically selecting the transmission link from a number of transmission links based on transmission link score 206 associated with each of the number of transmission links. Generating transmission link score 206 is described in greater detail below with reference to FIG. 5. In various embodiments, step 260 includes identifying candidate transmission links from the number of transmission links. For example, first device 202 may identify a number of candidate transmission links from the number of transmission links by comparing a size of a transmission to be transmitted from the selected device to a remaining transmission capacity associated with each of the number of transmission links. As a further example, first device 202 may determine that a size of first data packet 212 is 200 bytes and may select transmission links having at least 200 bytes in remaining transmission capacity as candidate transmission links. In some embodiments, the remaining transmission capacity is continuous (e.g., such that the transmission to be transmitted from the selected device does not need to be broken into pieces/can be transmitted as a single message). Identifying candidate transmission links is discussed in greater detail below with reference to FIG. 3. In some embodiments, step 260 includes generating a probability distribution associated with the candidate transmission links and probabilistically selecting the transmission link from the candidate transmission links based on the probability distribution. Generating a probability distribution associated with the candidate transmission links is described in greater detail below with reference to FIG. 4. In various embodiments, probabilistically selecting the transmission link includes generating a random value. For example, first device 202 may generate a random value and map the random value to a probability distribution to select the transmission link. As another example, a first transmission link may have a transmission link score of 0.4 and a second transmission link may have a transmission link score of 0.6 and first device 202 may generate a random value between zero and one and may select the first transmission link if the random value is less than 0.4 and may select the second transmission link if the random value is greater than or equal to 0.4.

At step 270, second device 210 may queue first data packet 212 in transmission queue 208 for transmission via the determined transmission link. In some embodiments, step 270 includes sending a data packet from a first networked device to a second networked device. For example, step 270 may include sending a data packet from second device 210 to first device 202 via a radio signal (e.g., a WiFi connection, etc.). As another example, step 270 may include sending a data packet from first device 202 to third device 220 via a radio signal. In some embodiments, steps 260-270 are repeated for each of a number of devices. For example, there may be ten devices that have data for transmission and steps 260-270 may be repeated for each of the ten devices according to their ranking/index (e.g., such that the device with the highest index is served first, the device with the second highest index is served second, etc.).

At step 280, first device 202 may update weight 214 and/or weight 224 based on whether data from second device 210 and/or third device 220 was added to a transmission queue. For example, if second device 210 was able to send data during a previous cycle and third device 220 was not able to send data during the previous transmission cycle, then first device 202 may update weight 214 and weight 224 to cause third device 220 to be prioritized relative to second device 210 in a subsequent transmission cycle.

Referring now to FIG. 3, method 300 for determining a transmission link is shown, according to an exemplary embodiment. As shown, FIG. 3 includes first device 310, second device 320, and a number of transmission links between first device 310 and second device 320 (shown as first transmission link 330, second transmission link 340, and third transmission link 350). In various embodiments, second device 320 transmits data packet 322 to first device 310 via one or more of first transmission link 330, second transmission link 340, and/or third transmission link 350. It should be understood that while FIG. 3 is described in relation to two devices having three transmission links therebetween, method 300 applies to a different number of devices and/or transmission links. In various embodiments, first device 310 is the same as and/or similar to first device 110 and/or first device 202. In various embodiments, second device 320 is the same as and/or similar to second device 120 and/or second device 210. In various embodiments, each of first transmission link 330, second transmission link 340, and third transmission link 350 have a corresponding transmission queue (shown as first transmission queue 332, second transmission queue 342, and third transmission queue 352, respectively). Each of first transmission queue 332, second transmission queue 342, and third transmission queue 352 may be associated with a transmission cycle (e.g., frame exchange phase, transmission phase, enhanced multi-link single-radio operation, etc.).

In various embodiments, a transmission cycle includes a link listening phase and a frame exchange phase. For example, a transmission cycle may take place during a time window and may include a listening phase occupying a first portion of the time window and a frame exchange phase occupying a second portion of the time window. As another example, a transmission cycle may include (i) a first device perceiving that a second device is listening on a number of transmission links (e.g., with one spatial stream per transmission link, etc.), (ii) obtaining, on a transmission link of the first device, a transmit opportunity (TXOP), (iii) sending, on a transmission link of the first device, a multiuser request to send (MU-RTS) trigger frame to the second device, (iv) receiving, from the second device, a clear to send (CTS) frame, and (v) performing, by the first device and the second device, a frame exchange phase (e.g., where the second device aggregates a number of spatial streams toward a transmission link, etc.).

In various embodiments, method 300 includes measuring a remaining transmission capacity associated with each of first transmission queue 332, second transmission queue 342, and/or third transmission queue 352. For example, first device 310 may determine that first transmission queue 332 has a remaining transmission capacity of 32 bytes, second transmission queue 342 has a remaining transmission capacity of 8 bytes, and third transmission queue 352 has a remaining transmission capacity of 64 bytes. In various embodiments, method 300 includes comparing the remaining transmission capacity associated with each transmission queue to a size of a transmission to be transmitted (e.g., by second device 320 and/or first device 310, etc.). In various embodiments, method 300 includes selecting those transmission links with the corresponding transmission queue having a remaining transmission capacity that is greater than or equal to a size of a transmission to be transmitted as candidate transmission links. For example, first device 310 may select first transmission link 330 and third transmission link 350 as candidate transmission links in response to determining that (i) a remaining transmission capacity of first transmission queue 332 and third transmission queue 352 is greater than a size of data packet 322 and/or (ii) a remaining transmission capacity of second transmission queue 342 is less than a size of data packet 322.

In various embodiments, method 300 includes identifying a set of transmission link indices which correspond to transmission links having sufficient remaining capacity to transmit a data packet to be sent by a device:

$${Λ}_{{j}_{m}} = \{ l : {r}_{l}^{′} \geq {b}_{{j}_{m}}^{x} , l = 1 , 2 , … , L \}$$

where jₘ is an index of M number of ranked devices, r′ₗ is the remaining transmission capacity of transmission link l, and bⱼ_{ₘ}^{x} is a size of a data packet to be sent by device jₘ (e.g., as measured in bytes, etc.). bⱼ_{ₘ}^{x} may include data to be transmitted downlink (DL) and/or data to be transmitted uplink (UL). In some embodiments, if Λⱼ_{ₘ}=Ø (e.g., there is no available link for the jₘ^{th} device), then the jₘ^{th} device cannot be accommodated in the link selection for the current time window and first device 310 may update a weight of second device 320 (e.g., wⱼ_{ₘ}←wⱼ_{ₘ}+1), thereby causing the jₘ^{th} device to be favored in subsequent transmission cycles. In some embodiments, if Λⱼ_{ₘ} is non-empty, then first device 310 may update a weight of second device 320 (e.g., wⱼ_{ₘ}=1).

Referring now to FIG. 4, method 400 for determining a transmission link is shown, according to an exemplary embodiment. As shown, FIG. 4 includes first device 410, second device 420, and a number of transmission links between first device 410 and second device 420 (shown as first transmission link 430, second transmission link 440, and third transmission link 450). First transmission link 430, second transmission link 440, and/or third transmission link 450 may be candidate transmission links. In various embodiments, first device 410 is the same as and/or similar to first device 110, first device 202, and/or first device 310. In various embodiments, second device 420 is the same as and/or similar to second device 120, second device 210, and/or second device 320. In various embodiments, each of first transmission link 430, second transmission link 440, and/or third transmission link 450 is associated with a transmission link score (shown as transmission link score 460). Transmission link score 460 may indicate a connection quality of an associated transmission link. For example, first transmission link 430 may have a first transmission link score 460 having a first value and second transmission link 440 may have a second transmission link score 460 having a second value that is greater than the first value. Generating transmission link scores is described in greater detail below with reference to FIG. 5.

In various embodiments, method 400 includes normalizing (shown as step 470) transmission link score 460 associated with first transmission link 430, second transmission link 440, and third transmission link 450. For example, transmission link score 460 may be normalized to produce a value (shown as value 472) for the one or more transmission links (e.g., first transmission link 430, second transmission link 440, and/or third transmission link 450). Value 472 may correspond to a probability of selecting the specific transmission link. For example, method 400 may include generating a value according to the formula:

$${value}_{{j}_{m} , l} = \frac{{ψ}_{{j}_{m} , l}}{{ψ}_{{j}_{m}}} ∈ [ 0 , 1 ] , l ∈ {Λ}_{{j}_{m}}$$

where ψⱼ_{ₘ}_{,l} is the transmission link score corresponding to transmission link/of device indexed jₘ and ψⱼ_{ₘ} is the sum of all the transmission link scores corresponding to transmission links associated with device indexed jₘ. In various embodiments, a sum of value 472 for each of the one or more transmission links equals one. In various embodiments, a transmission link for transmission is deterministically selected based on value 472. In various embodiments, method 400 includes generating categorical distribution 480 where the probability of selecting a link index is dependent on its corresponding assessed link quality. For example, probability distribution 480 may be generated according to the formula:

$$Cat ( {Λ}_{{j}_{m}} , {\{ {value}_{{j}_{m} , l} \}}_{l ∈ {Λ}_{{j}_{m}}} )$$

where valueⱼ_{ₘ}_{,l} is value 472 corresponding to transmission link l of the device indexed jₘ. To continue the example, a random number between zero and one may be determined and (i) if the number is between zero and 0.44 then first transmission link 430 may be selected, (ii) if the number is between 0.44 and 0.94 then second transmission link 440 may be selected, and (iii) if the number is between 0.94 and 1.0 then third transmission link 450 may be selected. In some embodiments, the transmission link for transmission is deterministically selected according to the algorithm:

```
Input:
  bₘ^{x}, wₘ, (ψ_{m,1}, ψ_{m,2}, . . . , ψ_{m,L}), m = 1, 2, . . . , M
  rₗ, l = 1, 2, . . . , L
Initialization: Φₗ = ∅, rₗ′ = rₗ′, l = 1, 2, . . . , L
form = 1:M
  ${u}_{m} = {w}_{m} * \frac{log ( {b}_{m}^{x} )}{{b}_{m}^{x}}$
end for
Sort in descending order:
  uⱼ_{₁} ≥ uⱼ_{₂} ≥ · · · ≥ uⱼ_{_{M}}, j₁, j₂, . . . , j_{M} ∈ {1, 2, . . . , M}
for m = 1:M
  Λⱼ_{ₘ} = {l: rₗ′ ≥ bⱼ_{ₘ}^{x}, l = 1, 2, . . . , L}
if Λⱼ_{ₘ} = Ø
  wⱼ_{ₘ} ← wⱼ_{ₘ} + 1
else
  wⱼ_{ₘ} = 1
  ${ψ}_{{j}_{m}} = {\sum }_{l ∈ {Λ}_{{j}_{m}}} {ψ}_{{j}_{m} , l}$
  ${value}_{{j}_{m} , l} = \frac{{ψ}_{{j}_{m} , l}}{{ψ}_{{j}_{m}}} ∈ [ 0 , 1 ] , l ∈ {Λ}_{{j}_{m}}$
  ${l}_{{j}_{m}}^{*} ∼ Cat ( {Λ}_{{j}_{m}} , {\{ {value}_{{j}_{m} , l} \}}_{l ∈ {Λ}_{{j}_{m}}} )$
  ${Φ}_{{l}_{{j}_{m}}^{*}} ← {Φ}_{{l}_{{j}_{m}}^{*}} ⋃ {j}_{m}$
  ${r}_{{l}_{{j}_{m}}^{*}}^{{}_{′}} ← {r}_{{l}_{{j}_{m}}^{*}}^{{}_{′}} - {b}_{{j}_{m}}^{x}$
end if
end for
Output: wₘ, m = 1, 2, ... M, Φₗ, l = 1, 2, ... , L
```

where bₘ^{x} is the total number of bytes to be transmitted (e.g., DL and/or UL) for the m^{th} device, wₘ is the weight associated with the m^{th} device, rₗ is the maximum number of bytes that can be transmitted through the lth channel (e.g., transmission link), Φₗ is the indices of client devices with data to be transmitted through the lth channel (e.g., transmission link), uₘ is the score for the m^{th} client device, and jₘ is the index of a selected device. In various embodiments, the algorithm may operate as follows: (i) a device (e.g., a client device, an access point, etc.) may receive a number of inputs (e.g., a weight associated with a number of devices, a size of a data transmission to be transmitted from the number of devices, a vector including a transmission link quality score associated with each transmission link of each of the number of devices, a remaining capacity for each transmission link, etc.), (ii) the device may generate a score for each of a number of devices based on a weight associated with each of the number of devices and a size of a data transmission to be transmitted from each of the number of devices, (iii) the device may sort the number of devices based on the scores, (iv) for each of the number of devices in descending order the device may determine a number of candidate transmission links based on the size of the data transmission to be transmitted from the number of devices and a remaining capacity for each transmission link associated with the currently selected device, (v) if there are no candidate transmission links for the currently selected device, a weight associated with the currently selected device may be updated, (vi) otherwise, the weight may be updated and the device may generate a value for each candidate transmission link based on a transmission link score associated with each candidate transmission link, (vii) the device may deterministically select a candidate transmission link based on the value associated with each candidate transmission link, (iix) the device may queue data to be transmitted in the selected candidate transmission link, and/or (ix) the device may update various parameters (e.g., a remaining transmission capacity associated with the selected candidate transmission link, etc.). In various embodiments, steps (iv)-(ix) may be repeated for each of the number of devices.

Referring now to FIG. 5, method 500 for generating a transmission link score is shown, according to an exemplary embodiment. As shown, FIG. 5 includes first device 510, second device 520, third device 530, and a number of transmission links between first device 510, second device 520, and third device 530 (shown as first transmission link 540, second transmission link 550, and third transmission link 560). In various embodiments, first device 510 is the same as and/or similar to first device 110, first device 202, first device 310, and/or first device 410. In various embodiments, second device 520 is the same as and/or similar to second device 120, second device 210, second device 320, and/or second device 420. In various embodiments, third device 530 is the same as and/or similar to third device 130 and/or third device 220. It should be understood that while FIG. 5 is shown including three devices and three transmission links, any number of devices and/or transmission links is possible. In brief, method 500 includes evaluating how a measurement of transmission link quality associated with a specific transmission link compares to all measurements of transmission link quality associated with all transmission links. In various embodiments, method 500 includes computing an empirical cumulative distribution function (eCDF) for each metric corresponding to each transmission link and generating a transmission link score based on the eCDF of each metric associated with each transmission link.

In various embodiments, method 500 includes generating a number of distributions (shown as first distribution 502, second distribution 504, and third distribution 506). Each of the distributions may correspond to a metric of transmission link quality. For example, first distribution 502 may correspond to a signal-to-noise ratio (SNR), second distribution 504 may correspond to an amount of data that has been received (e.g., a total number of bytes that have been received DL and/or UL), and third distribution 506 may correspond to a channel idle percentage.

In various embodiments, method 500 includes measuring one or more metrics of transmission quality. For example, first device 510 may measure a first set of metrics corresponding to first transmission link 540 (shown as first metrics 542), a second set of metrics corresponding to second transmission link 550 (shown as second metrics 552), and a third set of metrics corresponding to third transmission link 560 (shown as third metrics 562). In some embodiments, method 500 includes measuring a metric over a period of time and determining an average metric value. For example, first device 510 may measure an SNR corresponding to first transmission link 540 over a period of a week and may determine an average SNR corresponding to the first transmission link 540 over that period.

In various embodiments, method 500 includes generating one or more transmission link scores (shown as transmission link score 570) based on the number of distributions. In some embodiments, the one or more transmission link scores are generated according to the formula:

$$transmission link {score}_{m , l} = metric score {1}_{m , l} * metric score {2}_{m , l} * … * metric score {n}_{m , l}$$

where transmission link score_{m,l} (e.g., ψ_{m,l}) is transmission link score 570 corresponding to link/of device m and metric score n_{m,l} is a score indicating how a connection quality metric (of n connection quality metrics) associated with transmission link/of device m compares to other connection quality metrics of other transmission links of other devices. In various embodiments, metric score n_{m,l} is generated according to the formula:

$$metric score {n}_{m , l} = \frac{\vert \{ {metric}_{{m}^{′} , {l}^{′}} : {metric}_{{m}^{′} , {l}^{′}} \leq {metric}_{m , l} \} \vert}{ML}$$

where metric_{m′,l′} is a metric corresponding to link l′ of device m′. The one or more metrics of transmission quality may include a SNR (ξ_{m,l}), an amount of data received (b_{m,l}^{r}), a channel busy percentage (c_{m,l}) (e.g., channel occupancy, etc.), a channel idle percentage (ρ_{m,l}), and/or the like. In various embodiments, transmission link score 570 is generated according to the algorithm:

Input: ξ_{m,l}, b_{m,l}^{r}, c_{m,l}, l = 1, 2, . . . , L, m = 1, 2, . . . , M
for m = 1:M
ρ_{m,l} = 1 − c_{m,l}, l = 1, 2, . . . L
end for
for m = 1:M; for l = 1:L
$\overline{{ξ}_{m , l}} = \frac{\vert \{ {ξ}_{{m}^{′} , {l}^{′}} : {ξ}_{{m}^{′} , {l}^{′}} \leq {ξ}_{m , l} \} \vert}{M L}$
$\overline{{b}_{m , l}^{r}} = \frac{\vert \{ {b}_{{m}^{′} , {l}^{′}}^{r} : {b}_{{m}^{′} , {l}^{′}}^{r} \leq {b}_{m , l}^{r} \} \vert}{M L}$
$\overline{{ρ}_{m , l}} = \frac{\vert \{ {ρ}_{{m}^{′} , {l}^{′}} : {ρ}_{{m}^{′} , {l}^{′}} \leq {ρ}_{m , l} \} \vert}{M L}$
(l′ = 1, 2, . . . L, m′ = 1, 2, . . . M)
${ψ}_{m , l} = \overline{{ξ}_{m , l}} * \overline{{b}_{m , l}^{r}} * \overline{{ρ}_{m , l}}$
end for; end for
Output: (ψ_{m,1}, ψ_{m,2}, . . . , ψ_{m,L}), m = 1, 2, . . . , M

where ψ_{m,l} is a transmission link score for link/of device m. In various embodiments, the algorithm may operate as follows: (i) a device (e.g., a client device, an access point, etc.) may receive various inputs indicating transmission link quality corresponding to a number of transmission links (e.g., a total number of bytes that have been received UL and DL, a channel busy percentage, a SNR, etc.), (ii) the device may calculate a channel idle percentage associated with each transmission link of each of a number of devices, and/or (iii) the device may calculate a transmission link score for each transmission link of each of the number of devices based on the inputs indicating transmission link quality. In various embodiments, step (iii) is repeated for each transmission link of each of the number of devices.

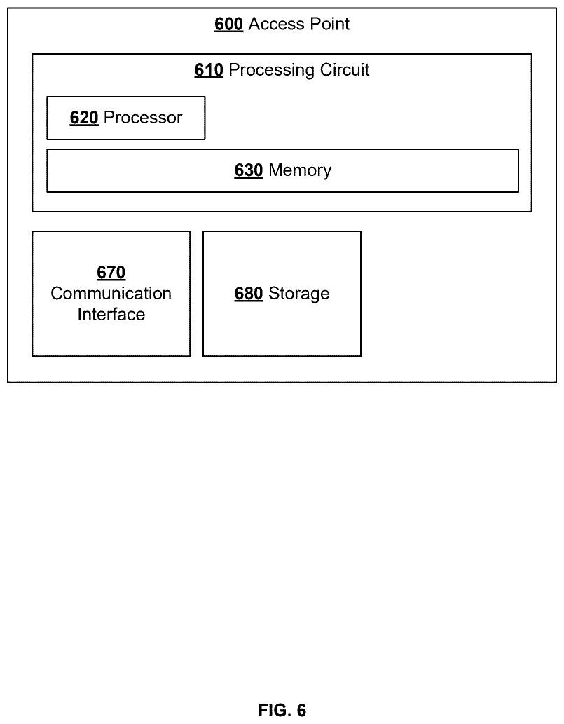

Referring now to FIG. 6, a block diagram of access point 600 is shown, according to an exemplary embodiment. In various embodiments, access point 600 determines a transmission link and queues data for transmission as described herein. Access point 600 may include processing circuit 610, communication interface 670 and/or storage 680. Processing circuit 610 may include processor 620 and/or memory 630. Processor 620 may be a general purpose or specific purpose processor, an application specific integrated circuit (ASIC), one or more field programmable gate arrays (FPGAs), a group of processing components, or other suitable processing components. Processor 620 is configured to execute computer code or instructions stored in memory 630 or received from other computer readable media (e.g., CDROM, network storage, a remote server, etc.). Memory 630 may include one or more devices (e.g., memory units, memory devices, storage devices, and/or other computer-readable media) for storing data and/or computer code for completing and/or facilitating the various processes described in the present disclosure. Memory 630 may include random access memory (RAM), read-only memory (ROM), hard drive storage, temporary storage, non-volatile memory, flash memory, optical memory, or any other suitable memory for storing software objects and/or computer instructions. Memory 630 may include database components, object code components, script components, or any other type of information structure for supporting the various activities and information structures described in the present disclosure. Memory 630 may be communicably connected to processor 620 via processing circuit 610 and may include computer code for executing (e.g., by processor 620) one or more of the processes described herein. For example, memory 630 may have instructions stored thereon that, when executed by processor 620, cause processing circuit 610 to determine a selected device based on a number of rankings, determine a transmission link for the selected device by probabilistically selecting the transmission link from a number of transmission links based on a transmission link score indicating a connection quality of the transmission link, and queue data from the selected device in a transmission queue for transmission via the determined transmission link.

Communication interface 670 may facilitate communication with one or more systems/devices. For example, access point 600 may communicate with a client device via communication interface 670. Communication interface 670 may be or include wired or wireless communications interfaces (e.g., jacks, antennas, transmitters, receivers, transceivers, wire terminals, etc.) for conducting data communications with external systems or devices. In various embodiments, communications via communication interface 670 is direct (e.g., local wired or wireless communications). Additionally or alternatively, communications via communication interface 670 may utilize a network (e.g., a WAN, the Internet, a cellular network, etc.).

Storage 680 may store one or more metrics indicating a connection quality associated with a transmission link. In some embodiments, storage 680 stores timeseries data. Storage 680 may be or include one or more memory devices (e.g., hard drive storage, temporary storage, non-volatile memory, flash memory, optical memory, and/or any other suitable memory device).

It should be understood that while this description references transmitting data from a client device to an access point, systems and methods of the present disclosure may be used to queue packets for wireless transmission in any direction. For example, systems and methods of the present disclosure may be used to transmit data from an access point to a client device and/or to transmit data from a client device to an access point (or any other networked device). Moreover, while certain steps are described as being performed by an access point, it should be understood that systems and methods of the present disclosure may be performed by any computing device. For example, a client device may implement the systems and methods of the present disclosure to queue packets for wireless transmission.

### Example #1

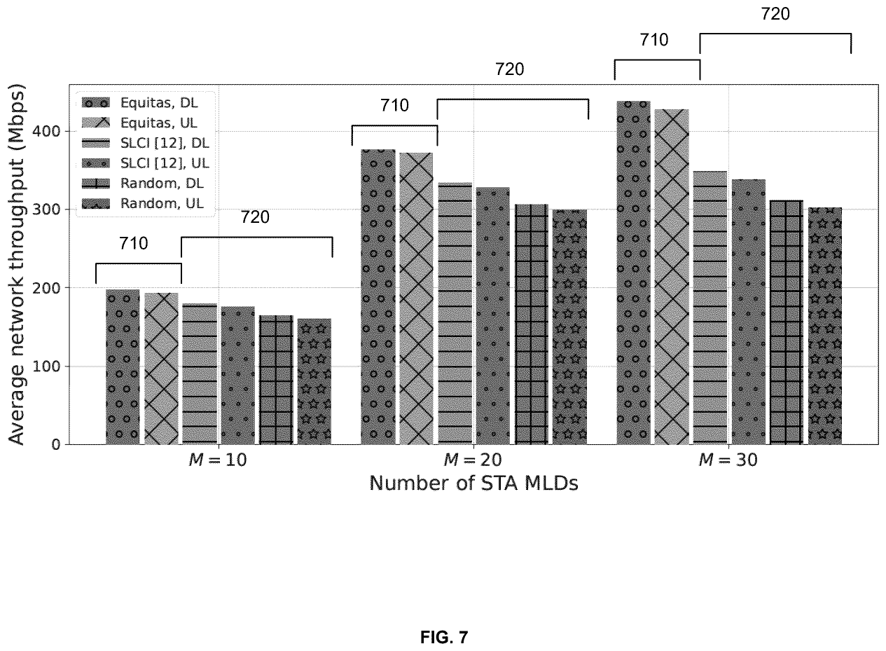

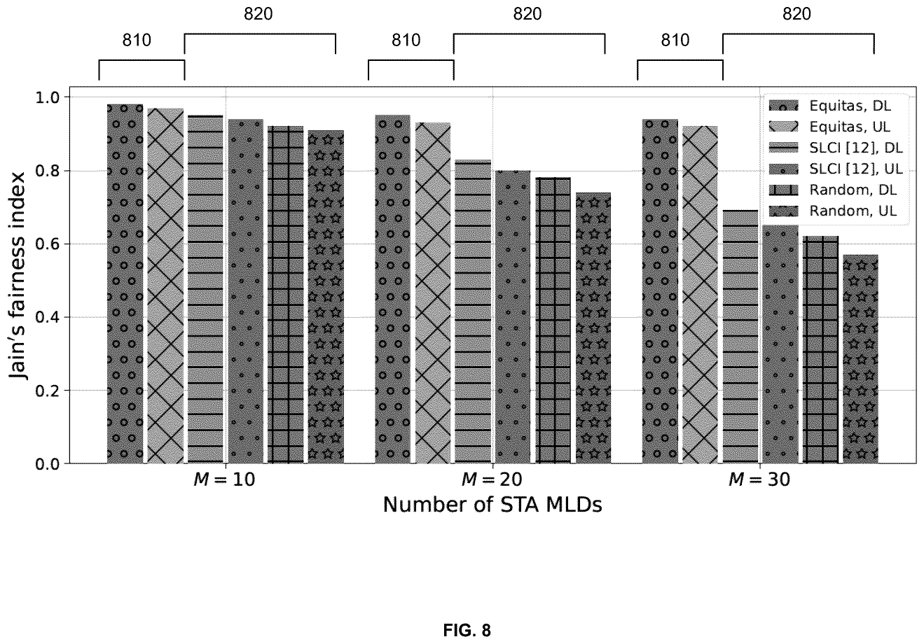

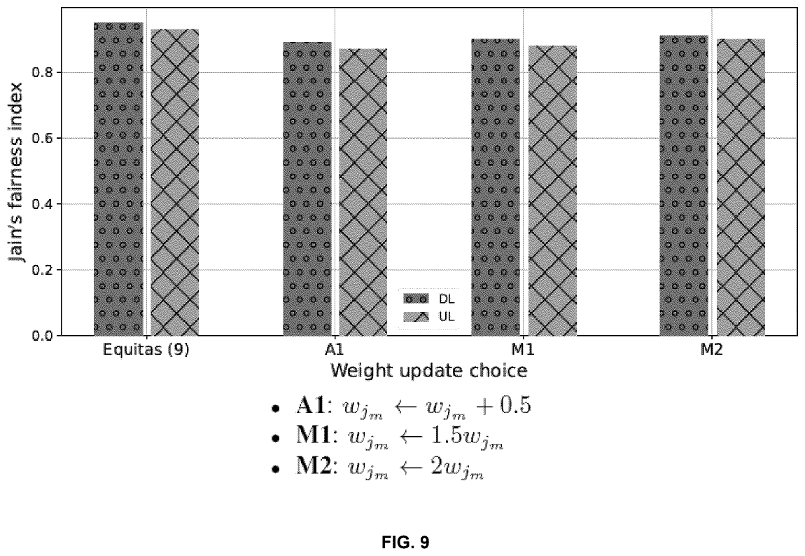

Referring now to FIGS. 7-9, graphs illustrating experimental results from a study that was conducted are shown, according to an exemplary embodiment. FIG. 7 illustrates a comparison of average network throughput between an implementation of the systems and methods of the present disclosure (shown as implementation 710) and conventional systems 720. As shown, implementation 710 produces higher average network throughput (as measured in Mbps) than conventional systems 720. For example, implementation 710 may produce higher average network throughput when used to queue data from ten, twenty, or thirty client devices (shown as STA MLDs in FIG. 7). FIG. 8 illustrates a comparison of Jain's fairness index between an implementation of the systems and methods of the present disclosure (shown as implementation 810) and conventional systems 820. Jain's fairness index may quantify the degree to which various devices receive a fair share of network resources (e.g., bandwidth, etc.). As shown, implementation 810 produces higher Jain's fairness index scores than conventional systems 820 when used to queue data from ten, twenty, or thirty client devices (shown as STA MLDs in FIG. 8). FIG. 9 illustrates a comparison of various weight updates choices. The weight update choices may include (i) wⱼ_{ₘ}←wⱼ_{ₘ}+1 (shown as “Equitas (9)” in FIG. 9), (ii) wⱼ_{ₘ}←ⱼ_{ₘ}+0.5 (shown as “A1” in FIG. 9), (iii) wⱼ_{ₘ}←1.5ⱼ_{ₘ} (shown as “M1” in FIG. 9), and (iv) wⱼ_{ₘ}←2ⱼ_{ₘ} (shown as “M2” in FIG. 9). As shown, wⱼ_{ₘ}←ⱼ_{ₘ}+1 may produce a higher Jain's fairness index score than other options.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

What is claimed is:

1. A method for queuing packets for wireless network transmission, comprising:
for each client device of a first client device and a second client device:
generating a weight for the client device, wherein the weight indicates a transmission priority associated with the client device;
generating a score for the client device based on (i) the weight and (ii) an amount of data to be transmitted from the client device; and
ranking the client device based on the score;
determining a selected device based on the rankings of the first client device and the second client device;
determining a transmission link for the selected device by probabilistically selecting the transmission link from a plurality of transmission links based on a transmission link score indicating a connection quality of the transmission link;
queuing data from the selected device in a transmission queue for transmission via the determined transmission link; and
updating the weight for each client device of the first client device and the second client device based on whether data from the client device was added to the transmission queue.

2. The method of claim 1, wherein determining the transmission link for the selected device comprises identifying, from the plurality of transmission links, candidate transmission links based on (i) an amount of data to be transmitted from the selected device and (ii) a remaining transmission capacity associated with each of the plurality of transmission links.

3. The method of claim 2, wherein determining the transmission link for the selected device comprises:
generating a probability distribution associated with the candidate transmission links based on a transmission link score associated with each of the candidate transmission links; and
wherein selecting the transmission link comprises selecting the transmission link based on the probability distribution.

4. The method of claim 1, further comprising:
generating the transmission link score based on an indication of a connection quality associated with each of the plurality of transmission links.

5. The method of claim 4, wherein the indication of a connection quality comprises at least one of (i) a signal-to-noise ratio, (ii) an amount of data received, or (iii) an indication of channel occupancy.

6. The method of claim 1, wherein updating the weight for the client device comprises updating the weight to increase the transmission priority associated with the client device in response to determining that the data from the client device was not added to the transmission queue.

7. The method of claim 1, wherein the transmission link is a wireless connection between the selected device and a wireless access point.

8. A wireless access point, comprising:
a processing circuit having a processor and memory, the memory having instructions stored thereon that, when executed by the processor, cause the processor to:
for each client device of a plurality of client devices:
generate a weight for the client device, wherein the weight indicates a transmission priority associated with the client device;
generate a score for the client device based on (i) the weight and (ii) an amount of data to be transmitted from the client device; and
rank the client device based on the score;
determine a selected device based on the rankings;
determine a transmission link for the selected device by probabilistically selecting the transmission link from a plurality of transmission links based on a transmission link score indicating a connection quality of the transmission link;
queue data from the selected device in a transmission queue for transmission via the determined transmission link; and
updating the weight for each client device of the plurality of client devices based on whether data from the client device was added to the transmission queue.

9. The wireless access point of claim 8, wherein determining the transmission link for the selected device comprises identifying, from the plurality of transmission links, candidate transmission links based on (i) an amount of data to be transmitted from the selected device and (ii) a remaining transmission capacity associated with each of the plurality of transmission links.

10. The wireless access point of claim 9, wherein determining the transmission link for the selected device comprises:
generating a probability distribution associated with the candidate transmission links based on a transmission link score associated with each of the candidate transmission links; and
wherein selecting the transmission link comprises selecting the transmission link based on the probability distribution.

11. The wireless access point of claim 8, wherein the instructions further cause the processor to:
generate the transmission link score based on an indication of a connection quality associated with each of the plurality of transmission links.

12. The wireless access point of claim 11, wherein the indication of a connection quality comprises at least one of (i) a signal-to-noise ratio, (ii) an amount of data received, or (iii) an indication of channel occupancy.

13. The wireless access point of claim 8, wherein updating the weight for the client device comprises updating the weight to increase the transmission priority associated with the client device in response to determining that the data from the client device was not added to the transmission queue.

14. A non-transitory computer-readable storage medium having instructions stored thereon that, when executed by a processor, cause the processor to:
determine a selected device from a plurality of devices based on a ranking associated with each of the plurality of devices;
determine a transmission link for the selected device by probabilistically selecting the transmission link from a plurality of transmission links based on a transmission link score indicating a connection quality of the transmission link;
queue data from the selected device in a transmission queue for transmission via the determined transmission link; and
update a weight for each of the plurality of devices based on whether data from each of the plurality of devices was added to the transmission queue, wherein the weight indicates a transmission priority.

15. The non-transitory computer-readable storage medium of claim 14, wherein determining the transmission link for the selected device comprises identifying, from the plurality of transmission links, candidate transmission links based on (i) an amount of data to be transmitted from the selected device and (ii) a remaining transmission capacity associated with each of the plurality of transmission links.

16. The non-transitory computer-readable storage medium of claim 15, wherein determining the transmission link for the selected device comprises:
generating a probability distribution associated with the candidate transmission links based on a transmission link score associated with each of the candidate transmission links; and
wherein selecting the transmission link comprises selecting the transmission link based on the probability distribution.

17. The non-transitory computer-readable storage medium of claim 14, wherein the instructions further cause the processor to:
generate the transmission link score based on an indication of a connection quality associated with each of the plurality of transmission links.

18. The non-transitory computer-readable storage medium of claim 17, wherein the indication of a connection quality comprises at least one of (i) a signal-to-noise ratio, (ii) an amount of data received, or (iii) an indication of channel occupancy.

19. The non-transitory computer-readable storage medium of claim 14, wherein updating the weight for each of the plurality of devices comprises updating the weight to increase the transmission priority associated with the device in response to determining that the data from the device was not added to the transmission queue.

20. The non-transitory computer-readable storage medium of claim 14, wherein the transmission link is a wireless connection between the selected device and a wireless access point.
